(19) United States
(12) Patent Application Publication
(10) Pub. No.: US 2020/0076306 A1
(43) Pub. Date: Mar. 5, 2020

(54) BUCK/BOOST CONTROLLER MODES

(71) Applicant: QUALCOMM Incorporated, San Diego, CA (US)

(72) Inventors: Stuart Pullen, Raleigh, NC (US); William Rader, Carrboro, NC (US)

(21) Appl. No.: 16/556,068

(22) Filed: Aug. 29, 2019

Related U.S. Application Data
(60) Provisional application No. 62/726,021, filed on Aug. 31, 2018.

(51) Int. Cl. H02M 3/158; H02M 1/08

(52) U.S. Cl. CPC H02M 3/1582; H02M 1/08

(57) ABSTRACT

A buck-or-boost switching regulator circuit includes an analog control circuit that generates a control signal to control the buck-or-boost switching regulator circuit to operate in different modes including a buck mode, a boost mode, and a pass mode. A first amplifier in the control loop circuit generates a first error signal based on one or more of an output voltage, an input current and an output current of the buck-or-boost switching regulator, and a reference voltage. The control signal is based on the first error signal. A control signal adjustment circuit, coupled to an output of the first amplifier, prevents the control signal from getting high enough to be sliced by a boost voltage ramp signal or to be low enough to be sliced by a buck voltage ramp signal based on an input voltage and an output voltage of the buck-or-boost switching regulator circuit.

### CROSS-REFERENCE TO RELATED APPLICATION

The present application claims the benefit of U.S. Provisional Patent Application No. 62/726,021, filed on Aug. 31, 2018, and titled “BUCK/BOOST CONTROLLER MODES,” the disclosure of which is expressly incorporated by reference in its entirety.

### TECHNICAL FIELD

The present disclosure generally relates to power management integrated circuits (PMICs). More specifically, aspects of the present disclosure relate to non-inverting buck-or-boost converters configured to operate in one or more forced modes.

### BACKGROUND

Many modern electronic systems specify some form of power conversion and rely on one or more batteries for power. The batteries are recharged, for example, by connecting the system to a power source (e.g., an alternating current (AC) power outlet) via a power adapter and cable. Power conversion circuits or power supply (e.g., a voltage regulator) are useful during different operation conditions. The operating conditions may include providing power to a phone and charging a battery of the phone when an adapter is plugged in, powering the phone when the battery is discharged, and powering an external device from the battery by reversing a current path.

A power supply may simply provide an output voltage that is higher or lower than an input voltage to avoid staying in a buck or boost mode and to switch between the two modes. For example, an input of the power supply can be a battery or another power supply. An output of the power supply can be a system or a battery to receive power from the power supply for charging the battery or for system operations.

### SUMMARY

A buck-or-boost switching regulator circuit includes an analog control circuit. The analog control circuit generates a control signal to control the buck-or-boost switching regulator circuit to operate in different modes including a buck mode, a boost mode, and a pass mode. The buck-or-boost switching regulator circuit also includes a first amplifier in the analog control circuit. The first amplifier generates a first error signal based on an output voltage, an input current and/or an output current of the buck-or-boost switching regulator, and a reference voltage. The control signal is based on the first error signal. The buck-or-boost switching regulator circuit further includes a control signal adjustment circuit coupled to an output of the first amplifier. The control signal adjustment circuit prevents the control signal from getting high enough to be sliced by a boost voltage ramp signal or to be low enough to be sliced by a buck voltage ramp signal based on an input voltage and an output voltage of the buck-or-boost switching regulator circuit.

A method includes receiving a feedback signal based on an output voltage, an input current and/or an output current of a buck-or-boost switching regulator circuit. The method also includes generating a control signal based on a first error signal. The first error signal is based on the feedback signal relative to a reference voltage. The method further includes adjusting the control signal based on a comparison of the output voltage and an input voltage of the buck-or-boost switching regulator circuit. The control signal is adjusted to prevent the control signal from getting high enough to be sliced by a boost voltage ramp signal or to be low enough to be sliced by a buck voltage ramp signal based on an input voltage and an output voltage of the buck-or-boost switching regulator circuit.

A buck-or-boost switching regulator circuit includes an analog control circuit. The analog control circuit generates a control signal to control the buck-or-boost switching regulator circuit to operate in different modes including a buck mode, a boost mode, and a pass mode. The buck-or-boost switching regulator circuit also includes means for generating a first error signal based on an output voltage, an input current and/or an output current of the buck-or-boost switching regulator and a reference voltage. The first error signal generating means is within the analog control circuit. The control signal is based on the first error signal. The buck-or-boost switching regulator circuit further includes a control signal adjustment circuit coupled to an output of the first error signal generating means. The control signal adjustment circuit prevents the control signal from getting high enough to be sliced by a boost voltage ramp signal or to be low enough to be sliced by a buck voltage ramp signal based on an input voltage and an output voltage of the buck-or-boost switching regulator circuit.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows a wireless device communicating with a wireless system.

FIG. 2 is a schematic diagram of a buck-or-boost converter in accordance with a buck mode operation.

FIG. 3 is a schematic diagram of a buck-or-boost converter in accordance with a boost mode operation.

FIG. 4 is a schematic diagram of a buck-or-boost converter illustrating a pass mode operation in accordance with an aspect of the present disclosure.

FIG. 5 is a schematic diagram of a buck-or-boost converter including a pulse width modulation (PWM) based analog control loop to achieve the pass-through mode in accordance with one or more aspects of the present disclosure.

FIG. 6 illustrates a waveform of a buck-or-boost converter when the buck-or-boost converter transitions from a buck mode operation to a pass-through mode operation to a boost mode operation, according to aspects of the present disclosure.

FIG. 7A illustrates a buck-or-boost switching regulator circuit, according to aspects of the present disclosure.

FIG. 7B illustrates a buck-or-boost switching regulator circuit, according to aspects of the present disclosure.

FIG. 8 depicts a simplified flowchart of a method of overriding control of a buck-or-boost switching regulator circuit, according to one aspect of the disclosure.

FIG. 9 depicts a simplified flowchart of a method of overriding control of a buck-or-boost switching regulator circuit according to one aspect of the disclosure.

FIG. 10 is a block diagram showing an exemplary wireless communications system in which a buck-or-boost switching regulator circuit of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR” and the use of the term “or” is intended to represent an “exclusive OR”.

The popularity of portable equipment (e.g., smartphones, portable computers, etc.) has driven technology and the desire for converting power efficiently. Direct current-direct current (DC-DC) converters called switching regulators (often referred to simply as “switchers”) are especially suitable for use in portable electronic devices, and can either step-up (boost) or step-down (buck) DC electrical power. Switching regulators used in portable electronic devices include a class of switching converters called buck-or-boost (BoB) switching converters. The kind of buck-or-boost switchers used in portable electronic devices operate in buck mode and in boost mode. In buck mode, a voltage at an input port is bucked to produce a regulated voltage at an output port. In boost mode, a voltage at the input port is boosted to produce a regulated voltage at the output port. In one aspect, an output voltage of the buck-or-boost switching converter is a constant voltage and the input voltage (e.g., from a voltage device such as a battery) can be above or below the output voltage. The output of the buck-or-boost switching converter can also be regulated to other values besides a constant voltage. For example, the output (which could be the battery or a universal serial bus (USB) power delivery (PD) input) may change its voltage during charging and discharging, and therefore the regulating may be of a current level rather than a voltage level. The battery or power supply generating the input voltage V_{IN} can charge and discharge during operation.

Non-inverting buck-or-boost (BoB) architectures of the switching regulators or converters have been evolving towards better efficiency. For example, conventional four-switch buck-or-boost converters that have four field effect transistors (4-FETs)) switching at each clock period have evolved to a control loop or analog control circuit (e.g., an analog control circuit) that switches only two field effect transistors (2-FETs) at each cycle (e.g., buck-or-boost operation). A non-inverting buck-or-boost (BoB) converter includes a buck (step-down) converter combined with a boost (step-up) converter. Such a non-inverting buck-or-boost converter may use a single inductor, as both the buck inductor and the boost inductor.

In one configuration, a buck-or-boost switching regulator or buck-or-boost converter may include a high side buck transistor coupled to an input voltage node, a high side boost transistor coupled to an output voltage node, a low side buck transistor coupled to the high side buck transistor, and a low side boost transistor coupled to the high side boost transistor. The buck-or-boost converter may also include an inductor coupled to the high side buck transistor, the high side boost transistor, the low side buck transistor, and the low side boost transistor. Additionally, the buck-or-boost converter includes a control loop (e.g., an analog control loop).

The analog control loop turns ON the high side buck transistor and the high side boost transistor, and turns OFF the low side buck transistor and the low side boost transistor in accordance with a pass-through mode of operation. For example, the control loop provides one or more drive signals to the gates of the transistors to turn the transistors ON and OFF in accordance with the pass-through mode. Turning the transistors ON and OFF corresponds to closing and opening switches. For example, one or more of the drive signals from the analog control circuit causes the high side buck transistor and the high side boost transistor to close or be turned ON. Similarly, another one or more of the drive signals from the analog control loop circuit causes the low side buck transistor and the low side boost transistor to open or be turned OFF.

The turning ON of the high side transistors and the turning OFF of the low side transistors shorts the input voltage node to the output voltage node to prevent switching of the transistors when a voltage difference between the input voltage node and the output voltage node is small. The pass-through mode of operation occurs when the input voltage V_{IN} is substantially equal to the output voltage V_{OUT} of the BoB converter. The definition of “substantially equal” is given by the DC gain characteristic of the system of which the control loop is a constituent part. For example, this voltage window can represent a threshold percentage (e.g., up to +/−1%) of output voltage of the regulator.

In some aspects of the disclosure, the analog control circuit includes an amplifier (e.g., an error amplifier) to receive a feedback signal based on the voltage at the output voltage node (e.g., V_{OUT}) and to generate an error signal based on the voltage at the output voltage node relative to a reference voltage. The analog control circuit also includes a second error amplifier that compares the error signal (e.g., Vea1) to a scaled inductor current and to generate a second error signal (e.g., Vea2). The analog control circuit also includes a comparator to compare the second error signal with a boost voltage ramp signal and a buck voltage ramp signal. The comparator outputs a control signal to control switching of the buck-or-boost switching regulator circuit.

Efficiency of the BoB architecture may be improved by reducing an amount of switching of the BoB architecture. For example, when the input voltage (e.g., this input voltage may be referred to as V_{IN_equivalent}) and the output voltage are equivalent (or approximately equal), switching of high side FETs (or high side switches) is prevented (no switching). For example, the high side switches are maintained in an ON state, which is equivalent to shorting the input voltage to the output voltage.

Aspects of the present disclosure are directed to an average current mode implementation for improving the efficiency of the buck-or-boost architecture. The architecture is configured in accordance with the average current mode implementation with two pulse width modulation (PWM) ramp signals (e.g., the boost voltage ramp signal and the buck voltage ramp signal) and two PWM comparators. For example, control of the buck-or-boost switching regulator turns ON both the high side buck transistor and the high side boost transistor with the clock and the low side buck transistor turns ON when the second error signal crosses the buck voltage ramp signal and the low side boost transistor turns ON when the second error signal crosses the boost ramp. If no ramp is crossed, the controller remains in the pass-through mode of operation. When either of the low side buck transistor or the low side boost transistor turns ON, the corresponding high side transistors (e.g., high side buck transistor and high side boost transistor) turn OFF.

In one aspect of the disclosure, a method of overriding control of a buck-or-boost switching regulator circuit is described. The method includes receiving a feedback signal based on an output voltage, an input current, and/or an output current of the buck-or-boost switching regulator circuit. A control signal is generated based on a first error signal. The first error signal is based on the feedback signal relative to a reference voltage. The control signal is adjusted based on a comparison of the output voltage (e.g., an average output voltage) and an input voltage (e.g., an average input voltage) of the buck-or-boost switching regulator circuit to prevent the control signal (Vea2) from getting high enough to be sliced by a boost voltage ramp signal or to be low enough to be sliced by a buck voltage ramp signal based on an input voltage and an output voltage of the buck-or-boost switching regulator circuit. For example, the control signal Vea2, which is at a voltage that is smaller than the boost ramp, increases from the smaller voltage until it crosses or slices a valley of the boost ramp. Similarly, the control signal Vea2, which is at a voltage that is greater than the buck ramp, decreases from the greater voltage until it crosses or slices a peak of the buck ramp. According to the aspects of the present disclosure, the control signal is prevented from slicing the peak of the buck ramp and a valley of the boost ramp.

Preventing the control signal from slicing the peak of the buck ramp and the valley of the boost ramp allows the buck-or-boost switching regulator circuit to re-enter buck mode quickly. For example, clamp circuits used to implement aspects of the present disclosure may include a buck clamp and a boost clamp. The buck clamp prevents the second error signal from rising into the boost ramp, which also keeps the second error signal near the top of the buck ramp. Accordingly, the buck clamp allows the second error signal to move back into the buck ramp quickly without having to pass through any portion of the boost ramp. The boost clamp prevents the second error signal from falling into the buck ramp. Accordingly, the boost clamp allows the second error signal to quickly re-enter the boost ramp. The output voltage and the input voltage may be filtered before the comparison. The buck-or-boost switching regulator circuit may be used in a battery charging circuit.

Aspects of the present disclosure incorporate a reverse power mode (e.g., on-the-go (OTG) mode), or other modes, such as dual role mode based on universal serial bus (USB) power delivery (PD) specifications, to deliver such higher voltage or higher current levels via direct charge. For example, an output load can be a system load and/or a battery. For example, when operating in a sink mode an adapter is plugged in (e.g., to a phone) to power the system and charge the battery. However, when operating in on-the-go or power delivery source mode, the phone battery is the input and can be used to charge an external battery or power supply. The regulator or power supply described can operate as a buck sometimes and boost other times based on input and output voltages.

### System Overview

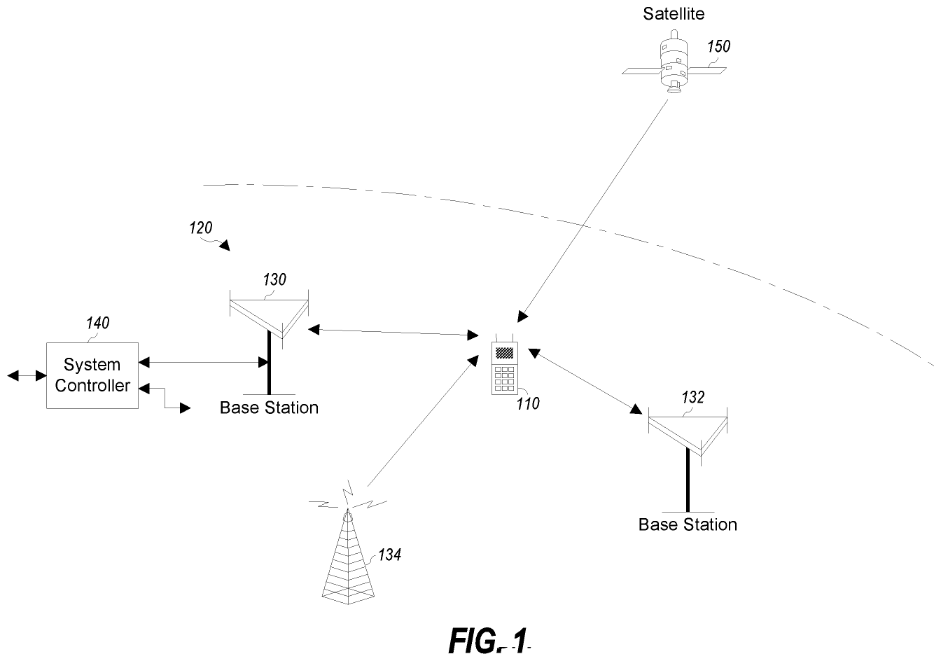

FIG. 1 shows a wireless device 110, which may include the disclosed buck-or-boost switching regulator circuit communicating with a wireless communications system 120. The wireless communications system 120 may be a 5G system, a long term evolution (LTE) system, a code division multiple access (CDMA) system, a global system for mobile communications (GSM) system, a wireless local area network (WLAN) system, millimeter wave (mmW) technology, or some other wireless system. A CDMA system may implement wideband CDMA (WCDMA), time division synchronous CDMA (TD-SCDMA), CDMA2000, or some other version of CDMA. In a millimeter wave (mmW) system, multiple antennas are used for beamforming (e.g., in the range of 30 GHz, 60 GHz, etc.). For simplicity, FIG. 1 shows the wireless communications system 120 including two base stations 130 and 132 and one system controller 140. In general, a wireless system may include any number of base stations and any number of network entities.

A wireless device 110 may also be referred to as a user equipment (UE), a mobile station, a terminal, an access terminal, a subscriber unit, a station, etc. The wireless device 110 may be a cellular phone, a smartphone, a tablet, a wireless modem, a personal digital assistant (PDA), a handheld device, a laptop computer, a Smartbook, a netbook, a cordless phone, a wireless local loop (WLL) station, a Bluetooth device, etc. The wireless device 110 may include the protection circuit and may be capable of communicating with the wireless communications system 120. The wireless device 110 may also be capable of receiving signals from broadcast stations (e.g., a broadcast station 134), signals from satellites (e.g., a satellite 150) in one or more global navigation satellite systems (GNSS), etc. The wireless device 110 may support one or more radio technologies for wireless communications such as LTE, CDMA2000, WCDMA, TD-SCDMA, GSM, 802.11, etc.

The wireless device 110 may support carrier aggregation, which is operation on multiple carriers. Carrier aggregation may also be referred to as multi-carrier operation. According to an aspect of the present disclosure, the wireless device 110 may be able to operate in low-band from 698 to 960 megahertz (MHz), mid-band from 1475 to 2170 MHz, and/or high-band from 2300 to 2690, ultra-high band from 3400 to 3800 MHz, and long-term evolution (LTE) in LTE unlicensed bands (LTE-U/LAA) from 5150 MHz to 5950 MHz. Low-band, mid-band, high-band, ultra-high band, and LTE-U refer to five groups of bands (or band groups), with each band group including a number of frequency bands (or simply, “bands”). For example, in some systems each band may cover up to 200 MHz and may include one or more carriers. For example, each carrier may cover up to 40 MHz in LTE. Of course, the range for each of the bands is merely exemplary and not limiting, and other frequency ranges may be used. LTE Release 11 supports 35 bands, which are referred to as LTE/UMTS bands and are listed in 3GPP TS 36.101. The wireless device 110 may be configured with up to five carriers in one or two bands in LTE Release 11.

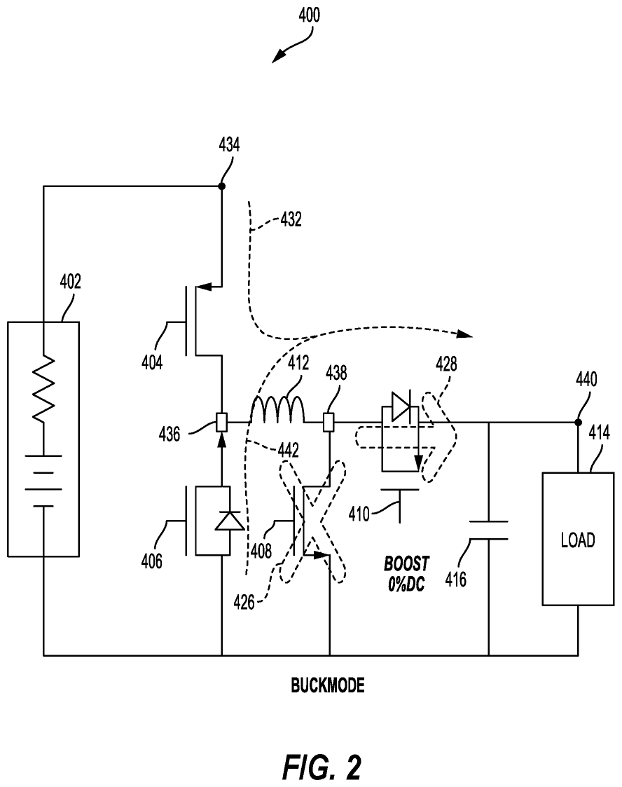

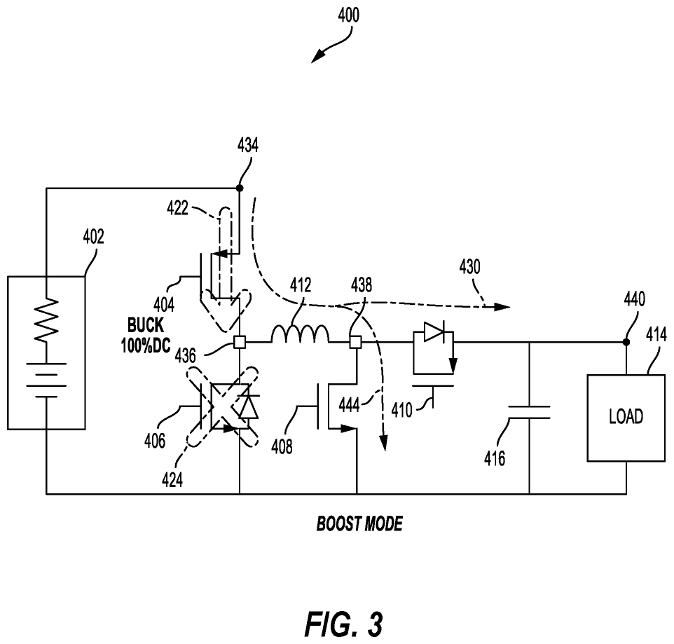

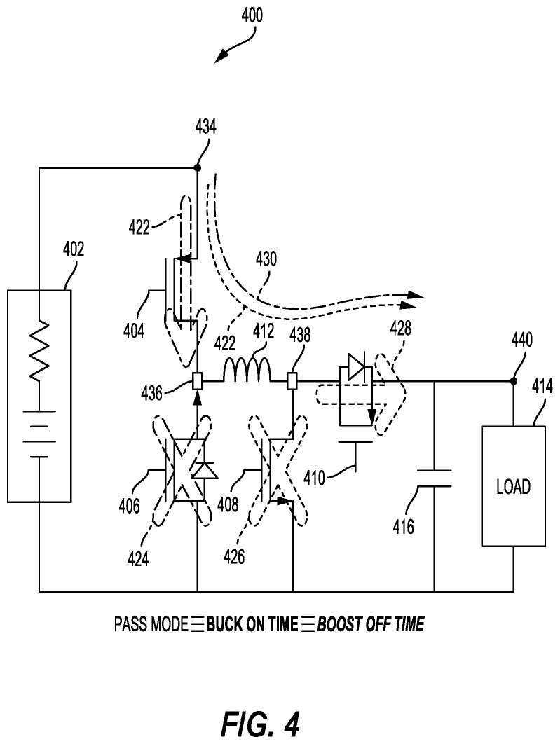

FIGS. 2-4 illustrate schematic diagrams of a power stage buck-or-boost converter 400, showing different modes of operations. In the buck mode of operation of FIG. 2, the input voltage V_{IN} is higher than the output voltage V_{OUT}. In the boost mode of operation of FIG. 3, the output voltage V_{OUT} is higher than the input voltage V_{IN}. In the pass-through mode of operation of FIG. 4, the input voltage V_{IN} is substantially equal to the output voltage V_{OUT}. In some implementations, the buck-or-boost converter 400 may be used in a portable electronic device or user equipment (not shown) to provide a regulated power supply to system electronics via a system output V_{OUT}.

The buck-or-boost converter 400 includes an input voltage node 434 into which the input voltage V_{IN} is applied. The input voltage V_{IN} may be supplied by a voltage supply device 402 that is coupled to the input voltage node 434. The buck-or-boost converter 400 also includes a high side buck transistor 404 and a low side buck transistor 406. The high side buck transistor 404 may be a P-channel transistor having its source/drain path connected between the input voltage node 434 and a node 436. The low side buck transistor 406 may be an N-channel transistor having its drain/source path connected between the node 436 and ground. An inductor 412 is connected between the node 436 and a node 438. Although the high and low side transistors are specifically described as N-channel or P-channel transistors, the P-channel and N-channel transistors can be interchangeable. For example, the high side buck transistor 404 may be an N-channel transistor.

The buck-or-boost converter 400 also includes a high side boost transistor 410 and a low side boost transistor 408. The high side boost transistor 410 may be a P-channel boost transistor that has its source/drain path connected between an output voltage node 440 and the node 438. The low side boost transistor 408 may be an N-channel transistor having its source/drain path connected between the node 438 and ground. As it is well understood by people skilled in the art, the high side buck and boost transistors can also be implemented by N-channel transistors. Furthermore, all the switching transistors can be implemented by bipolar transistors or any other suitable controlled switching devices. An output capacitor 416 is connected between the output voltage node 440 and ground. An output load 414 is connected in parallel with the output capacitor 416 between the output voltage node 440 and ground. In some aspects, the output load 414 can be a system load and/or a battery. For example, when operating in a sink mode, an adapter is plugged in (e.g., to a phone) to power the system and charge the battery. However, when operating in on-the-go (OTG) or power delivery (PD) source mode, the phone battery is the input and can be used to charge an external battery or power. Therefore, the regulator or power supply described herein can operate as a buck sometimes and boost other times based on input and output voltages. Each of the high side buck transistor 404, low side buck transistor 406, high side boost transistor 410, and low side boost transistor 408 have their gates connected to feedback circuitry or the control loop (not shown). The control loop generates gate control signals via a set of outputs based on the output voltage V_{OUT} applied from output voltage node 440.

Referring to FIG. 2, the buck-or-boost converter 400 operates in a buck mode, where an input voltage V_{IN} is bucked to a lower voltage level and provided as a regulated voltage level at the output voltage or system output V_{OUT}. This is achieved by opening and closing one or more switches at a duty cycle. The control loop is based on a feedback voltage, which is compared to a reference signal at an error amplifier (EA).

Very high duty cycle at the nominal F_{SW} (switching frequency) is limited by the minimum achievable low side pulse (or by a maximum duty cycle limit applied to the control loop) and is generally on the order of a few percent of a full period. To achieve very high duty cycle during operation, a control loop operates to modulate the switching frequency operation in sub-multiples of Fsw clock (e.g., Fsw/2, Fsw/3, . . . ) until the very high duty cycle is achieved. The 100% duty cycle is an extension of this operation, where no switching is observed.

For example, a control loop (not shown) is operated to produce drive signals to drive the high side buck transistor 404 and the low side buck transistor 406 to operate as a buck regulator. The drive signals may comprise pulse width modulated pulses that operate the high side buck transistor 404 and the low side buck transistor 406 so that high side buck transistor 404 is ON when the low side buck transistor 406 is OFF, and vice versa. For example, when the high side buck transistor 404 is ON, current flows in a direction 432. However, when the low side buck transistor 406 is ON, current flows in a direction 442. The high side boost transistor 410 is maintained continuously ON to provide a path to the output voltage V_{OUT}, while the low side boost transistor 408 is OFF.

Referring to FIG. 3, the buck-or-boost converter 400 operates in a boost mode, where an input voltage V_{IN} is boosted to a higher voltage level and provided as a regulated voltage level at the output voltage or system output V_{OUT}. Accordingly, the control loop (e.g., analog control circuit), may be operated to produce drive signals to drive the high side boost transistor 410 and the low side boost transistor 408 to operate as a boost regulator. The drive signals may comprise pulse width modulated pulses that operate the high side boost transistor 410 and the low side boost transistor 408 so that the high side boost transistor 410 is ON when the low side boost transistor 408 is OFF, and vice versa. For example, when the high side boost transistor 410 is ON, current flows in a direction 430. However, when the low side boost transistor 408 is ON, current flows in a direction 444. The high side buck transistor 404 is maintained continuously ON to provide a path from the input voltage V_{IN}, while the low side buck transistor 406 is OFF. The boost mode operation is the counterpart of buck mode, and the pass-through from V_{IN} to V_{OUT} (high side transistors 404 and 410 ON) represents a 0% boost operation duty cycle. A very low duty cycle is achieved when the control loop modulates the Fsw operation in a similar fashion as explained above for buck operation. In this case, the 0% duty cycle represents the state when no switching event is observed.

Referring to FIG. 4, the buck-or-boost converter 400 operates in a pass-through mode, when a voltage level V_{OUT}, at the output voltage node 440, is substantially equal to the voltage level V_{IN}, at the input voltage node 434. In the pass-through mode, the input voltage V_{IN} is shorted to the output voltage V_{OUT} through the inductor 412 in series with the two high side transistors (e.g., 404 and 410). For example, to short the input voltage to the output, the low side buck transistor 406 and the low side boost transistor 408 are turned OFF as respectively indicated by crosses 424 and 426, while the high side buck transistor 404 and the high side boost transistor 410 are turned ON to allow current to flow in directions 422, 428, and 430. Pass-through mode operation occurs when the input voltage V_{IN} and the output voltage V_{OUT} are substantially equal where the control loop operates the buck transistors in 100% duty cycle and the boost transistors in 0% duty cycle. The transistors are maintained in this state as long as the output voltage V_{OUT} is in regulation, no matter the value of the load current. For example, pass-through mode is achieved when the input voltage V_{IN} minus the voltage drop caused by the path resistance (high side FETs+inductor resistance) multiplied by the load current is equal to the output voltage V_{OUT}(V_{IN}−Rpath*Iload=V_{OUT}).

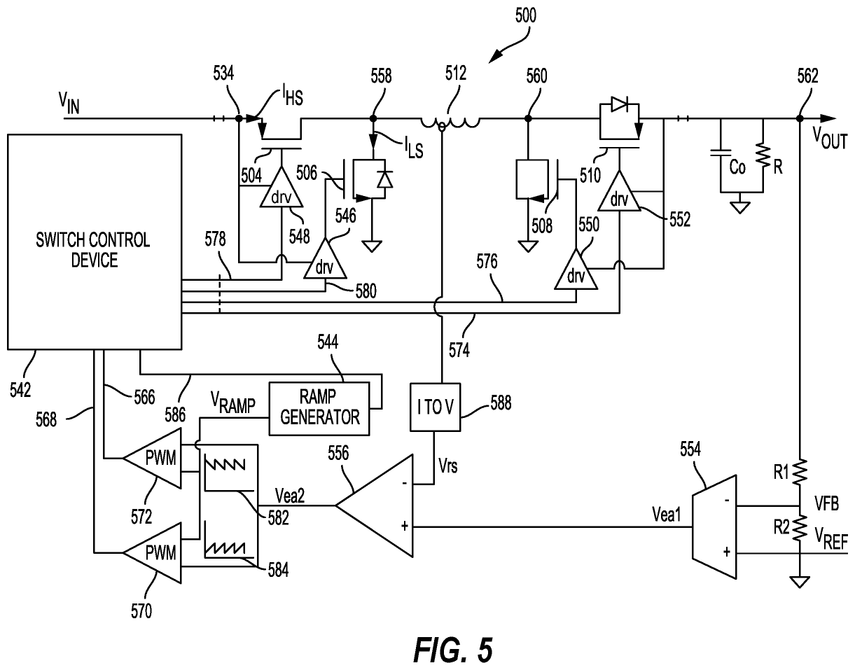

FIG. 5 is a schematic diagram of a buck-or-boost converter 500 including a pulse width modulation (PWM)-based analog control loop to achieve the pass-through mode in accordance with one or more aspects of the present disclosure. The schematic of FIG. 5 illustrates a pulse width modulation (PWM) implementation.

The buck-or-boost converter 500 includes a high side buck transistor 504, a low side buck transistor 506, a high side boost transistor 510, a low side boost transistor 508, an inductor 512, a capacitor Co, and a load illustrated by R. The load may be one or more electronic circuits, such as an integrated circuit, for example. One terminal of the transistor 504 receives input voltage V_{IN} (e.g., at node 534) and the other terminal of the transistor 504 is coupled to a switching node (e.g., 558) having a voltage V_{SW}. One terminal of the transistor 506 is coupled to the switching node 558 and the other terminal of the transistor 506 is coupled to a reference voltage (e.g., ground). One terminal of the transistor 510 is coupled to the inductor 512 at a node 560 and the other terminal of the transistor 510 is coupled to an output node (e.g., 562) having a voltage V_{OUT}. One terminal of the transistor 508 is coupled to the node 560 and the other terminal of the transistor 508 is coupled to a reference voltage (e.g., ground). Drivers 546 and 548 turn the transistors 504 and 506 ON and OFF while drivers 550 and 552 turn the transistors 508 and 510 ON and OFF.

The transistors 504, 506, 508, and 510 act as switches to selectively couple nodes in the circuit together. While transistors 504 and 510 are P-channel transistors and transistors 506 and 508 are N-channel transistors in this example, it is to be understood that other switch structures and arrangements may be used. The example switching regulator architecture shown here is just one of many switching topologies that may use the techniques described herein.

To cause the buck-or-boost converter 500 to operate in the pass-through mode, an analog control loop is coupled to the buck-or-boost converter 500 to provide the drive signals for turning ON and turning OFF the transistors. The analog control loop includes a switch control device 542, a ramp generator 544, a comparing device 556 (e.g., a comparator) or second error amplifier, and a first error amplifier 554. The analog control loop also includes a buck PWM comparator (BuA) 570, and a boost PWM comparator (BoA) 572. The pass-through mode implementation is applicable to an average-current-mode control, as well as a simple voltage-mode control, where a voltage Vea1 directly feeds one of the inputs of the PWM comparators 570 or 572.

For example, the high side buck transistor 504, the low side buck transistor 506, the high side boost transistor 510, and the low side boost transistor 508 are configured by the switch control device 542 to alternately charge and discharge the inductor 512. The inductor 512 is coupled to the load R, and current from the inductor 512 supports an output voltage V_{OUT} at the load R. The current through the high side buck transistor 504 is labeled I_{HS}, and the current through the low side buck transistor 506 is labeled I_{LS}. The positive flow of current I_{HS} is defined as flowing in the direction from a source of the high side buck transistor 504 to a drain of the high side buck transistor 504, as illustrated by the arrow in FIG. 5.

The switch control device 542 controls the transistors (e.g., 504, 506, 508, 510) based on input signals 566 and 568 derived from V_{OUT} (e.g., according to the control loop implementation as further described). A voltage sensing implementation, such as a voltage divider including a first resistor R1 and a second resistor R2, senses the output voltage V_{OUT} and generates a voltage VFB. An amplifier 554 subtracts VFB from a reference voltage V_{REF} to generate an amplified output of the first error signal Vea1. The first error signal Vea1 is compared to a signal Vrs (which represents the inductor current) by the current amplifier 556 and generates the second error signal Vea2. The ramp signal V_{RAMP} is generated by the ramp generator 544. For example, the ramp generator 544 produces the ramp signal V_{RAMP} having a period and the PWM comparators 572 and 570 receive the ramp signal V_{RAMP} and the second error signal Vea2 to generate PWM signals 566 and 568, which accordingly modulate the switching transistors 504, 506, 508, and 510.

In one aspect of the disclosure, the analog control loop may be implemented in accordance with pulse width modulation (PWM). The buck and the boost duty cycle are generated by two independent PWM comparators (e.g., buck PWM comparator 570 and boost PWM comparator 572). Each comparator is fed by its respective ramp (not shown), originated in the ramp generator 544, in one of the input terminals and by the error signal Vea2 originated from the amplifier 556, in the other input terminal. For example, the ramp generator 544 generates respective a buck ramp and boost ramp, to be compared with the error signal Vea2. The error signal, which is the output voltage from the second error amplifier, transitions throughout the buck and boost ramp in order to generate a desirable buck and boost PWM signal to regulate the output voltage V_{OUT}. The buck and boost PWM signals control the switching of the high side buck transistor 504, the low side buck transistor 506, the high side boost transistor 510 and the low side boost transistor 508, of FIG. 5.

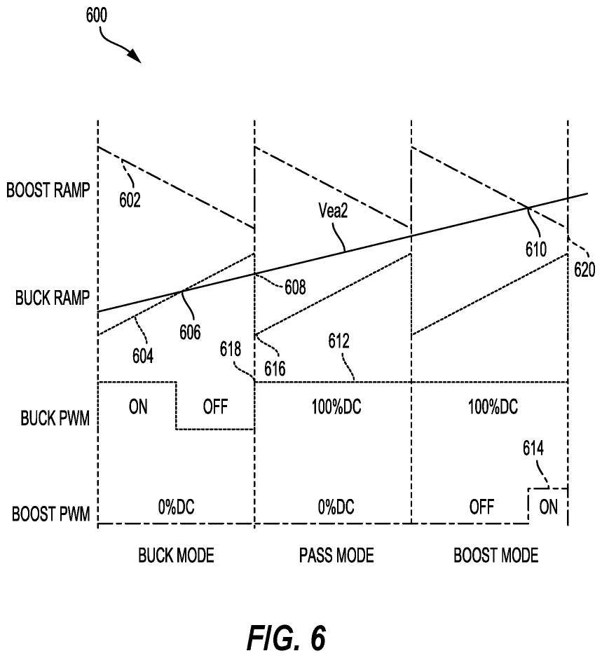

For example, to achieve the pass-through mode of operation, 100% duty cycle buck operation and 0% duty cycle boost operation are simultaneously achieved. The control loop positions the error signal Vea2 above the buck ramp and simultaneously below the boost ramp. For example, the positioning of the error signal Vea2 is achieved by establishing a gap window between the buck and the boost ramp, as seen in FIG. 6. In some implementations, 100% buck duty cycle and 0% boost duty cycle may be generated using only one ramp. In this case, the error signal Vea2 may be offset to obtain two signals vea2a and vea2b, but still using two PWM comparators and generating two distinct PWM signals (one for buck and one for boost).

To achieve the pass-through mode of operation, the switch control device 542 controls the transistors 504, 506, 508, and 510 based on input signals 566 and 568 derived from V_{OUT}. The input signals 566 and 568 (also the output signals of the BoA 572 and the BuA 570, respectively) may be a pulse-width modulated (PWM) output signals corresponding to the boost PWM and the buck PWM, respectively. The boost PWM and buck PWM are provided to the switch control device 542, which generates gate control voltages or control signals 574, 576, 578, and 580 to turn the transistors ON and OFF.

For example, the input signal 568 may be used to control the high side buck transistor 504 and the low side buck transistor 506. Similarly, the input signal 566 may be used to control the high side boost transistor 510 and the low side boost transistor 508. For example, the error signal Vea2 is maintained within the gap such that an input boost ramp voltage 582 of the boost PWM comparator (BoA) 572 is higher than the error signal Vea2 and an input buck ramp voltage 584 of the buck PWM comparator (BuA) 570 is below the error signal Vea2. In some aspects of the disclosure, the input boost ramp voltage 582 and the input buck ramp voltage 584 may be generated by the ramp generator 544 or a different ramp generator. For example, during every cycle, the switch control device 542 may reset the value of the input buck ramp voltage 584 back to zero or an offset value. To reset the ramps, the switch control device 542 may generate a reset signal 586 to the ramp generator 544 or any other generator generating the ramp signals. Thus, in some implementations, the input boost ramp voltage 582 and the input buck ramp voltage 584 may be generated based on the sensed current I_{HS} of the high side buck transistor 504. For example, the current on the buck-or-boost high side FET can be sensed whether or not the converter is operating in a buck or boost mode. In other implementations, the ramp signals may be based on voltage or other parameters.

In operation, (e.g., when Vea2 is generated to fall within the gap or other instances), the output of the BoA 572 (also the input signal 566 to the switch control device 542) causes the switch control device 542 to generate control signals through the drivers 550 and 552 to the gates of the high side boost transistor 510 and the low side boost transistor 508. In addition, the output of the BuA 570 (also the input signal 568 to the switch control device 542) causes the switch control device 542 to generate control signals through the drivers 546 and 548 to the gates of the high side buck transistor 504 and the low side buck transistor 506.

For example, the control signal 574 causes the high side boost transistor 510 to be turned ON and the control signal 576 causes the low side boost transistor 508 to be turned OFF for the pass-through mode of operation. Similarly, the control signal 578 causes the high side buck transistor 504 to be turned ON and the control signal 580 causes the low side buck transistor 506 to be turned OFF for the pass-through mode of operation. The control implementation is illustrated in FIG. 6.

FIG. 6 illustrates a waveform 600 of a buck-or-boost converter when the buck-or-boost converter transitions from a buck mode of operation to pass-through mode of operation to a boost mode of operation. The waveform 600 shows the error signal Vea2 across a range of voltage values over time. The waveform 600 also shows a boost ramp 602 and a buck ramp 604 across a range of voltage values over time. For example, the boost ramp 602 corresponds to the input boost ramp voltage 582 and the buck ramp corresponds to the input buck ramp voltage 584 of FIG. 5.

For illustrative purposes, the three operation modes are shown in three subsequent clock cycles. For example, the implementation of FIG. 6 illustrates a representation of the buck-or-boost operation when a battery voltage (input voltage of buck-or-boost) goes through a complete discharging cycle of operation. For example, the fully charged battery generates input voltage for the buck-or-boost that is higher than the output voltage. In this case, the control loop error signal Vea2 (e.g., error voltage) and buck and boost PWM signals behave like the buck mode illustration of FIG. 2. In the OTG mode, the battery is the input. In this OTG mode, when the battery voltage and load current are such that the input voltage V_{IN} is substantially equal to the output voltage (e.g., this input voltage may be referred to as V_{IN_equivalent}), the control loop operates in the pass-through mode as illustrated in FIG. 4. As the battery discharges with time, the input voltage V_{IN} falls below the output voltage V_{OUT} in accordance with a boost mode of operation as illustrated in FIG. 3. While the illustration corresponds to the discharging of the battery, a similar representation of the buck-or-boost operation may be achieved during input voltage V_{IN} and/or output current transients.

The error signal Vea2 is initially higher than the buck ramp 604 (e.g., up to point 606). As the buck ramp 604 gradually increases during the buck mode of operation, the buck ramp 604 intersects the error signal Vea2 at various points. For example, the buck ramp 604 crosses the error signal Vea2 at point 606. At this point, the high side buck transistor 504 is turned OFF and a low side buck transistor is turned ON in accordance with the duty cycle corresponding to a buck PWM signal 612. When the buck ramp 604 crosses the error signal Vea2, a duty cycle between 0% and 100% is established. This means that the V_{IN} is no longer substantially equivalent to V_{OUT}. The switch control device 542 then causes the buck ramp 604 to reset to zero (or an offset value) at point 616. The generation of the PWM signal renders the ramp unnecessary or unimportant until the next period is started. Each cycle period is created by an Fsw clock.

The buck ramp 604 intersects the error signal Vea2 again when the buck ramp 604 is reset. Accordingly, when the error signal Vea2 is less than the maximum value of the buck ramp 604 and greater than a minimum value of V_{RAMP} (here, ground), the high side buck transistor 504 is turned ON in accordance with the duty cycle corresponding to the buck PWM signal 612. When the buck ramp 604 is less than the error signal Vea2 (e.g., between points 608 and 610), the buck PWM signal 612, transitions to high at point 618.

As the error signal Vea2 gradually increases, the boost ramp 602 intersects the error signal Vea2 at various points. For example, the boost ramp 602 crosses the error signal Vea2 at point 610. At this point, the high side boost transistor 510 is turned OFF and the low side boost transistor is turned ON in accordance with the duty cycle corresponding to a boost PWM signal 614. When the boost ramp 602 crosses the error signal Vea2, a duty cycle between 0% and 100% is established. The switch control device 542 then causes the boost ramp 602 to reset at point 620. Unlike conventional PWM control, the buck-or-boost implementation discussed in accordance with aspects of the present disclosure turns the boost high side transistor ON at the beginning of each Fsw cycle. For example, each cycle starts in the boost OFF-time (when the inductor current is delivered to the load). The boost PWM signal 614 defines the time when boost high side is turned OFF and boost low side is turned ON. When boost low side is ON the inductor is charged and it lasts until the cycle expires.

The analog loop control of the buck-or-boost converter is based on the boost ramp 602 and the buck ramp 604. Every cycle (clock gated) starts in the pass-through equivalent mode of operation because whether the input voltage is higher or lower than the output voltage (and any value in between), each cycle starts with buck high side and boost high side transistors ON, until any of the PWM (buck-or-boost) signals assert or a next cycle starts. The pass-through mode of operation at the start of the cycle corresponds to an observation phase where the analog control loop tests the input voltage V_{IN} and the output voltage V_{OUT} levels. If V_{IN} is greater than V_{OUT}, the inductor current increases and charges the output voltage V_{OUT}. The control loop then provides the error signal Vea2 to generate the buck PWM signal 612 with a desirable or specified duty cycle. If V_{IN} is less than V_{OUT}, the inductor current discharges and consequently discharges the output voltage V_{OUT}. The control loop generates a desirable or specified boost PWM duty cycle.

When the input voltage is substantially equal to the output voltage V_{OUT} the inductor current charges or discharges. In this case, the control loop error signal Vea2 transitions to a desirable position in the gap between the buck and the boost ramps. To achieve a pass-through mode, the error signal Vea2 is maintained in a voltage window or gap between the boost ramp 602 and a buck ramp 604. For example, the error signal Vea2 is maintained between the points 608 and 610. In the pass-through mode, the switching regulator is conveniently positioned to transition to the boost mode of operation or the buck mode of operation when a transient occurs.

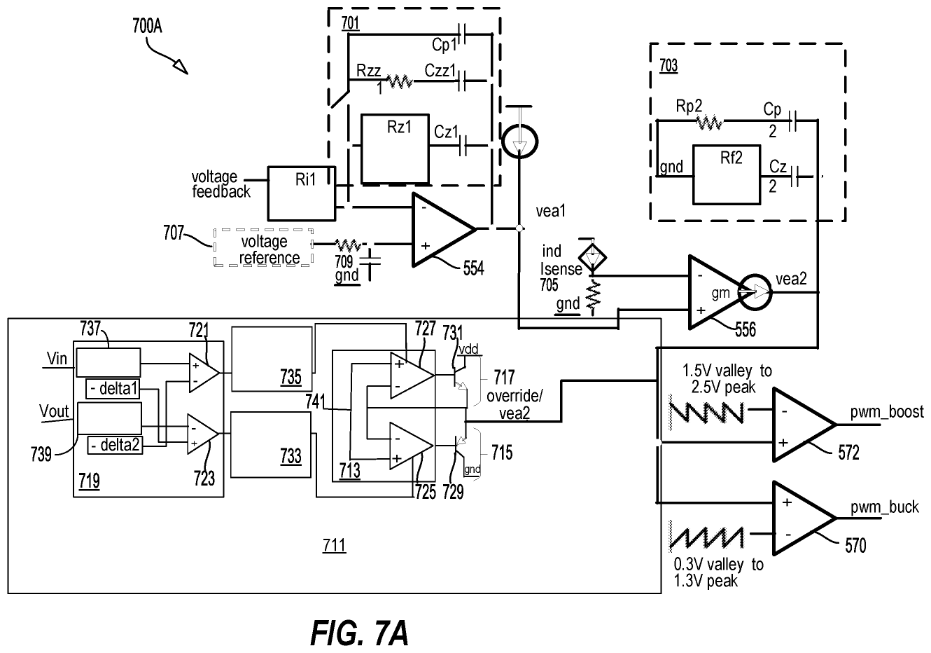

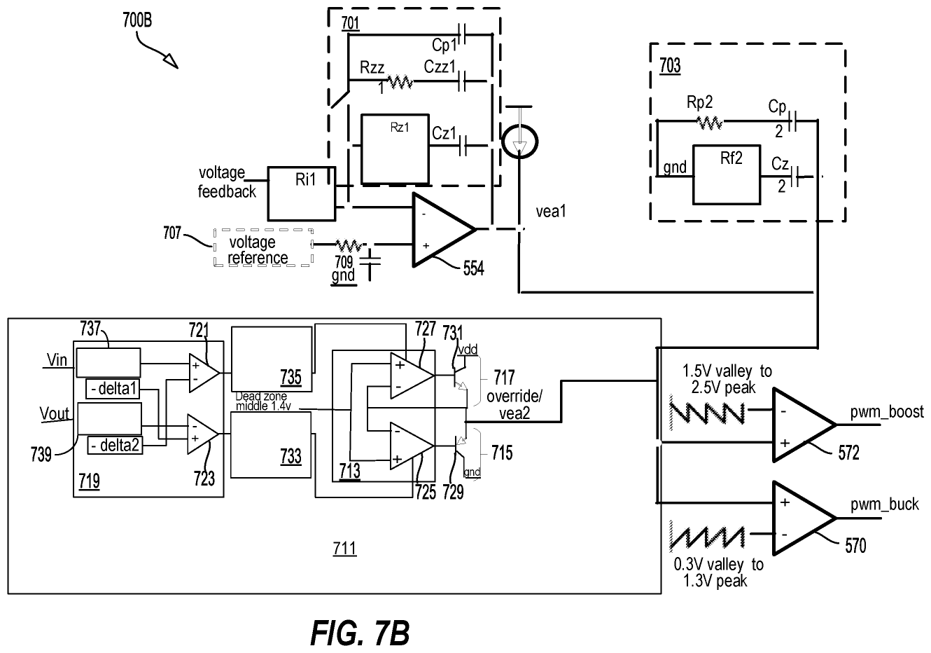

FIG. 7A illustrates a buck-or-boost switching regulator circuit 700A, according to aspects of the present disclosure. The buck-or-boost switching regulator circuit 700A includes an analog control circuit that includes a first amplifier (e.g., the first error amplifier 554) and its corresponding compensation circuit 701, a second amplifier (e.g., the comparing device 556) and its compensation circuit 703, an inductor current sensing circuit 705, the buck PWM comparator (BuA) 570, the boost PWM comparator (BoA) 572, and a control signal adjustment circuit 711. In some aspects, the control signal adjustment circuit 711 is coupled to the analog control circuit. The analog control circuit is configured to generate a control signal to control the buck-or-boost switching regulator circuit 700A to operate in different modes including a buck mode, a boost mode, and a pass mode.

The control signal adjustment circuit 711 may be integrated in the buck-or-boost switching regulator circuit 700A or separated but coupled to the buck-or-boost switching regulator circuit 700A. For example, the control signal adjustment circuit 711 is coupled to an output of the comparing device 556 and an input of the buck PWM comparator 570 and the boost PWM comparator 572. The control signal adjustment circuit 711 is configured to prevent the control signal from getting high enough to be sliced by a boost voltage ramp signal or to be low enough to be sliced by a buck voltage ramp signal based on an input voltage V_{IN} and an output voltage V_{OUT} of the buck-or-boost switching regulator circuit 700A. In one aspect, the input voltage V_{IN} and the output voltage V_{OUT} are provided to a first comparator 721 and a second comparator 723 after being filtered by a first filter 737 (e.g., a low pass filter that may be optional) and a second filter 739 (e.g., a low pass filter that may be optional).

The first error amplifier 554 is configured to receive a feedback signal (e.g., voltage feedback) based on an output voltage, an input current and/or an output current of the buck-or-boost switching regulator circuit 700A. The feedback signal may be received via an input resistor Ri1. A first error signal (e.g., the first error signal Vea1) may be generated by the first error amplifier 554. The first error signal is based on the feedback signal relative to a reference voltage 707. The reference voltage 707 may be provided to an input of the first error amplifier 554 via a resistor-capacitor filter 709. The control signal (e.g., the error signal Vea2 of FIG. 5) generated by the analog control circuit is based on the first error signal. The first error amplifier 554 may be in an outer loop of the analog control circuit and the comparing device 556 may be in an inner loop of the analog control circuit (as shown in FIG. 5).

The comparing device 556 is configured to generate a second error signal (e.g., the error signal Vea2 of FIG. 5) based on the first error signal and a current through an inductor (e.g., inductor 512 of FIG. 5) of the buck-or-boost switching regulator circuit 700A. The current is sensed by the inductor current sensing circuit 705. The control signal is based on the second error signal.

The control signal adjustment circuit 711 includes a clamp circuit 713 including a buck clamp 715 and a boost clamp 717. The control signal adjustment circuit 711 also includes one or more comparators 719 coupled to the clamp circuit 713. The one or more comparators 719 generate at least one enable signal to selectively enable the boost clamp 717 or the buck clamp 715 to adjust the control signal Vea2 to prevent the control signal Vea2 from getting high enough to be sliced by the boost ramp or low enough to be sliced by the buck ramp. The one or more comparators 719 include the first comparator 721 configured to selectively generate a first enable signal for the boost clamp 717 and the second comparator 723 configured to selectively generate a second enable signal for the buck clamp 715. The first enable signal and the second enable signal are based on a programmable voltage comparison between the input voltage and the output voltage of the buck-or-boost switching regulator circuit 700A.

In one aspect of the disclosure, the buck clamp 715 includes a third amplifier 725 coupled to a first transistor 729, and the boost clamp 717 includes a fourth amplifier 727 coupled to a second transistor 731. Each of the first transistor 729 and the second transistor 731 may be a bipolar junction transistor or a field effect transistor. For example, the first transistor 729 may be a P-type field effect transistor and the second transistor 731 may be an N-type field effect transistor.

The control signal adjustment circuit 711 includes a first delay circuit 733 (e.g., a rising edge delay circuit that may be optional) coupled between the third amplifier 725 and the second comparator 723. The control signal adjustment circuit 711 further includes a second delay circuit 735 (e.g., a rising edge delay circuit that may be optional) coupled between the fourth amplifier 727 and the first comparator 721.

Aspects of the present disclosure add forced buck and forced boost modes to improve the decision making capability of the analog control circuit. For example, when the input voltage V_{IN} is greater than a sum of the output voltage V_{OUT} and a first small voltage or first threshold voltage (e.g., delta1=one volt), a forced buck is active. The first threshold may be adjustable. In the forced buck active state, a peak of the control signal Vea2 is clamped to a dead zone middle 741 (or voltage window) between the boost ramp 602 and a buck ramp 604. The forced buck active state is configured to prevent the control signal Vea2 from inadvertently entering the boost mode, or to limit a number of cycles and duty cycle in the boost mode, in response to a load step, which can result in less voltage overshoot at new higher current levels. Thus, in a peak current limit (PCL), the control signal Vea2 is maintained or specified to be in buck mode.

When the output voltage V_{OUT} is greater than a sum of the input voltage V_{IN} and a second small voltage or second threshold voltage (e.g., delta2=three hundred and forty millivolts) a forced boost is active. The second threshold may be adjustable. In the forced boost active state, a valley of the control signal Vea2 is clamped to the dead zone middle 741 between the boost ramp 602 and a buck ramp 604. Thus, at light load, the control signal Vea2 falls to the dead zone middle 741 and can skip pulses, but it does not traverse the buck ramp 604. Therefore, current sinking is avoided in the forced boost active state. Additionally, when a positive load step happens, the control signal Vea2 can enter boost mode directly and avoid the buck region, thereby greatly speeding up the transient response. Forcing the boost mode prevents dangerously high sink currents after a negative load step when the input voltage V_{IN} is approximately equal to the output voltage V_{OUT}. Accordingly, the clamp (e.g., clamp circuit 713) prevents the control signal Vea2 from entering the buck mode and sinking current.

FIG. 7B illustrates a buck-or-boost switching regulator circuit 700B, according to aspects of the present disclosure. The buck-or-boost switching regulator circuit 700B includes an analog control circuit that generates a control signal to control the buck-or-boost switching regulator circuit 700B to operate in different modes including a buck mode, a boost mode, and a pass mode. The analog control circuit includes or is coupled to the first error amplifier 554. The buck-or-boost switching regulator circuit 700B includes a control signal adjustment circuit 711. In one aspect, the control signal adjustment circuit 711 is in the analog control circuit. The first error amplifier 554 generates the first error signal Vea1 based on an output voltage, an input current and/or an output current of the buck-or-boost switching regulator circuit 700B, and a reference voltage 707. The control signal is based on the first error signal Vea1.

The control signal adjustment circuit 711 is coupled to an output of the first error amplifier 554. The control signal adjustment circuit prevents the control signal from getting high enough to be sliced by a boost voltage ramp signal or to be low enough to be sliced by a buck voltage ramp signal based on an input voltage and an output voltage of the buck-or-boost switching regulator circuit 700B. The buck-or-boost switching regulator circuit 700B may operate in accordance with a voltage mode while the buck-or-boost switching regulator circuit 700A operates in accordance with an average current mode.

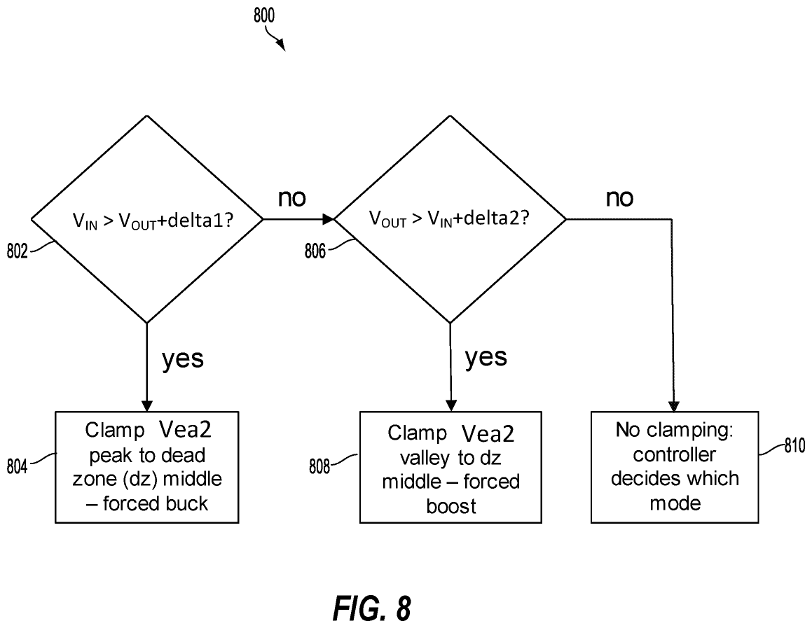

FIG. 8 depicts a simplified flowchart of a process 800 of overriding control of a buck-or-boost switching regulator circuit according to one aspects of the disclosure. The process 800 starts at block 802, where it is determined whether the input voltage V_{IN} is greater than a sum of the output voltage V_{OUT} and a first small voltage delta1. When the input voltage V_{IN} is greater than the sum of the output voltage V_{OUT} and the first small voltage delta1, the process continues to block 804 where the peak of the control signal Vea2 is clamped to a dead zone middle 741 to force a buck mode. Otherwise, when the input voltage V_{IN} is less than or equal to the sum of the output voltage V_{OUT} and the first small voltage delta1 the process continues to block 806.

At block 806, it is determined whether the output voltage V_{OUT} is greater than a sum of the input voltage V_{IN} and the second small voltage delta2. When the output voltage V_{OUT} is greater than the sum of the input voltage V_{IN} and a second small voltage delta2, the process continues to block 808 where the valley of the control signal Vea2 is clamped to the dead zone middle 741 to force a boost mode. Otherwise, when the output voltage V_{OUT} is less than or equal to the sum of the input voltage V_{IN} and the second small voltage delta2, the process continues to block 810. At block 810, a controller determines the mode of operation and there is no clamping. In some aspects, the output voltage V_{OUT} and the input voltage V_{IN} may be filtered by the first filter 737 and the second filter 739 before the comparison.

The buck-or-boost switching regulator circuit of this disclosure is less likely to toggle between modes and is therefore easier to stabilize. The buck-or-boost switching regulator circuit and corresponding implementation avoid dangerous negative currents and is less likely to be caught in an undesirable mode of operation. The features of the buck-or-boost switching regulator circuit also reduce dangerous voltage overshoots. Additionally, the buck-or-boost switching regulator circuit improves transient response in boost mode. For example, zero to two amplifier load steps are unacceptable without the forced boost mode. Without the forced boost mode, a zero to two amperes load step that occurs when the output voltage is significantly higher than the input voltage would have to pass through the boost ramp. This passing of the load step yields a negative inductor current before getting to the boost ramp, thereby increasing the average inductor current to two amperes.

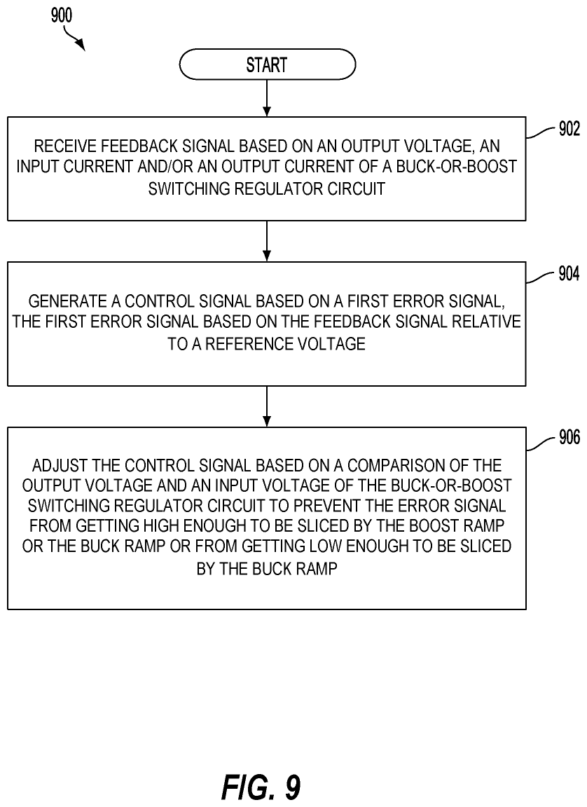

FIG. 9 depicts a simplified flowchart of a method 900 of overriding control of a buck-or-boost switching regulator circuit according to one aspects of the disclosure. At block 902, a feedback signal based on an output voltage, an input current and/or an output current of the buck-or-boost switching regulator circuit is received. At block 904, a control signal based on a first error signal is generated. The first error signal is based on the feedback signal relative to a reference voltage. At block 906, the control signal is adjusted based on a comparison of the output voltage and an input voltage of the buck-or-boost switching regulator circuit to prevent the error signal from getting high enough to be sliced by the boost ramp or the buck ramp or from getting low enough to be sliced by the buck ramp.

According to one aspect of the present disclosure, a buck-or-boost switching regulator circuit is described. The buck-or-boost switching regulator circuit includes means for generating a first error signal and means for generating a second error signal. The first error signal generating means may, for example, be the first error amplifier 554, as illustrated in FIGS. 5, 7A, and 7B. The second error signal generating means may, for example, be the second error amplifier 556, as illustrated in FIGS. 5 and 7A. In another aspect, the aforementioned means may be any module or any apparatus or material configured to perform the functions recited by the aforementioned means.

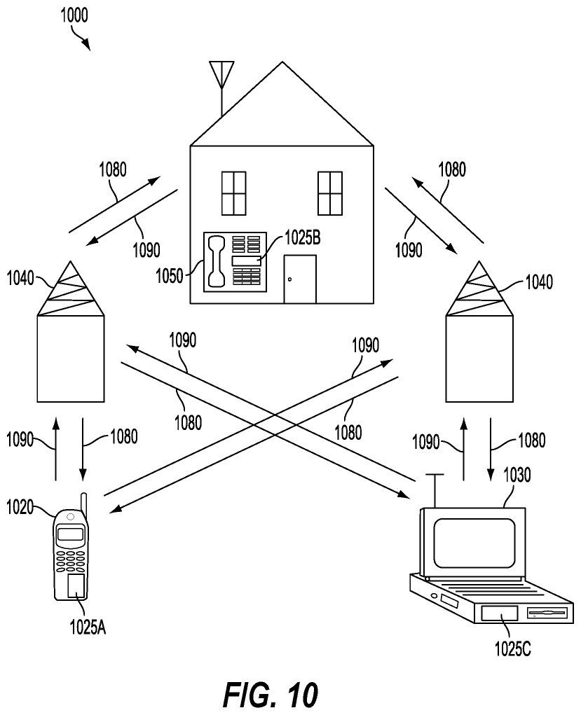

FIG. 10 is a block diagram showing an exemplary wireless communications system 1000 in which a buck-or-boost switching regulator circuit of the disclosure may be advantageously employed. For purposes of illustration, FIG. 10 shows three remote units 1020, 1030, and 1050 and two base stations 1040. It will be recognized that wireless communications systems may have many more remote units and base stations. Remote units 1020, 1030, and 1050 include IC devices 1025A, 1025C, and 1025B that include the disclosed buck-or-boost switching regulator circuit. It will be recognized that other devices may also include the disclosed buck-or-boost switching regulator circuit, such as the base stations, switching devices, and network equipment. FIG. 10 shows forward link signals 1080 from the base station 1040 to the remote units 1020, 1030, and 1050 and reverse link signals 1090 from the remote units 1020, 1030, and 1050 to base station 1040.

In FIG. 10, remote unit 1020 is shown as a mobile telephone, remote unit 1030 is shown as a portable computer, and remote unit 1050 is shown as a fixed location remote unit in a wireless local loop system. For example, a remote units may be a mobile phone, a hand-held personal communications systems (PCS) unit, a portable data unit such as a personal digital assistant (PDA), a GPS enabled device, a navigation device, a set top box, a music player, a video player, an entertainment unit, a fixed location data unit such as a meter reading equipment, or other communications device that stores or retrieve data or computer instructions, or combinations thereof. Although FIG. 10 illustrates remote units according to the aspects of the disclosure, the disclosure is not limited to these exemplary illustrated units. Aspects of the disclosure may be suitably employed in many devices, which include the buck-or-boost switching regulator circuit.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic device, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

What is claimed is:

1. A buck-or-boost switching regulator circuit comprising:
an analog control circuit configured to generate a control signal to control the buck-or-boost switching regulator circuit to operate in different modes including a buck mode, a boost mode and a pass mode;
a first amplifier, in the analog control circuit, configured to generate a first error signal based on one or more of an output voltage, an input current and an output current of the buck-or-boost switching regulator circuit and a reference voltage, the control signal based on the first error signal; and
a control signal adjustment circuit coupled to an output of the first amplifier, the control signal adjustment circuit configured to prevent the control signal from getting high enough to be sliced by a boost voltage ramp signal or to be low enough to be sliced by a buck voltage ramp signal based on an input voltage and an output voltage of the buck-or-boost switching regulator circuit.

2. The buck-or-boost switching regulator circuit of claim 1, further comprising a second amplifier in an inner loop of the analog control circuit, the second amplifier configured to generate a second error signal based on the first error signal and a current through an inductor of the buck-or-boost switching regulator circuit, the control signal based on the second error signal, the first amplifier in an outer loop of the analog control circuit.

3. The buck-or-boost switching regulator circuit of claim 2, in which the analog control circuit further comprises a third comparator and a fourth comparator each having an input coupled to the output of the second amplifier and an output of the control signal adjustment circuit.

4. The buck-or-boost switching regulator circuit of claim 3, in which the third comparator is configured to generate a mode control signal to control the buck-or-boost switching regulator circuit, the mode control signal based on the boost voltage ramp signal and an adjusted control signal from the control signal adjustment circuit.

5. The buck-or-boost switching regulator circuit of claim 3, in which the fourth comparator is configured to generate a mode control signal to control the buck-or-boost switching regulator circuit, the mode control signal based on the buck voltage ramp signal and an adjusted control signal from the control signal adjustment circuit.

6. The buck-or-boost switching regulator circuit of claim 2, further comprising:
a high side buck transistor coupled to an input voltage node;
a high side boost transistor coupled to an output voltage node;
a low side buck transistor coupled to the high side buck transistor;
a low side boost transistor coupled to the high side boost transistor; and
an inductor coupled to the high side buck transistor, the high side boost transistor, the low side buck transistor, the low side boost transistor, the first amplifier and the second amplifier.

7. The buck-or-boost switching regulator circuit of claim 6, in which the pass mode occurs when the high side buck transistor and the high side boost transistor are closed and the low side buck transistor and the low side boost transistor are open to short an input voltage node to an output voltage node of the buck-or-boost switching regulator circuit.

8. The buck-or-boost switching regulator circuit of claim 2, in which the control signal adjustment circuit further comprises:
a clamp circuit including a buck clamp and a boost clamp; and
at least one comparator coupled to the clamp circuit, the at least one comparator configured to generate at least one enable signal to selectively enable the boost clamp or the buck clamp to prevent the control signal from getting high enough to be sliced by the boost voltage ramp signal or to be low enough to be sliced by the buck voltage ramp signal based on the input voltage and the output voltage of the buck-or-boost switching regulator circuit.

9. The buck-or-boost switching regulator circuit of claim 8, in which the at least one comparator comprises a first comparator configured to selectively generate a first enable signal for the boost clamp and a second comparator configured to selectively generate a second enable signal for the buck clamp.

10. The buck-or-boost switching regulator circuit of claim 9, in which the first enable signal and the second enable signal are based on a programmable voltage comparison between the input voltage and the output voltage of the buck-or-boost switching regulator circuit.

11. The buck-or-boost switching regulator circuit of claim 8, in which the buck clamp comprises a third amplifier coupled to a first transistor, and the boost clamp comprises a fourth amplifier coupled to a second transistor.

12. The buck-or-boost switching regulator circuit of claim 11, in which each of the first transistor and the second transistor comprise a bipolar junction transistor or a field effect transistor.

13. The buck-or-boost switching regulator circuit of claim 8, in which the control signal adjustment circuit further comprises at least one delay circuit coupled between the clamp circuit and the at least one comparator.

14. The buck-or-boost switching regulator circuit of claim 2, in which the boost voltage ramp signal and the buck voltage ramp signal are separated by a gap to clamp the second error signal between the gap.

15. A method comprising:
receiving a feedback signal based on one or more of an output voltage, an input current and an output current of a buck-or-boost switching regulator circuit;
generating a control signal based on a first error signal, the first error signal based on the feedback signal relative to a reference voltage; and
adjusting the control signal based on a comparison of the output voltage and an input voltage of the buck-or-boost switching regulator circuit to prevent the control signal from getting high enough to be sliced by a boost voltage ramp signal or to be low enough to be sliced by a buck voltage ramp signal based on an input voltage and an output voltage of the buck-or-boost switching regulator circuit.

16. The method of claim 15, in which adjusting the control signal further comprises:
comparing the output voltage and the input voltage of the buck-or-boost switching regulator circuit;
generating at least one enable signal based on the comparison to selectively enable a boost clamp or a buck clamp; and
generating a prevent signal from the boost clamp or the buck clamp to prevent the control signal from getting high enough to be sliced by the boost voltage ramp signal or to be low enough to be sliced by the buck voltage ramp signal based on an input voltage and an output voltage of the buck-or-boost switching regulator circuit.

17. The method of claim 16, further comprising delaying the at least one enable signal according to a rising edge delay implementation.

18. The method of claim 16, in which generating at least one enable signal comprises:
generating a first enable signal for the boost clamp when the output voltage is greater than the input voltage by a first threshold; and
generating a second enable signal for the buck clamp when the input voltage is greater than the output voltage by a second threshold.

19. The method of claim 15, further comprising selectively comparing the adjusted control signal with the boost voltage ramp signal and the buck voltage ramp signal to generate a mode control signal to adjust a mode of operation of the buck-or-boost switching regulator circuit.

20. A buck-or-boost switching regulator circuit comprising:
an analog control circuit configured to generate a control signal to control the buck-or-boost switching regulator circuit to operate in different modes including a buck mode, a boost mode, and a pass mode;
means for generating a first error signal based on one or more of an output voltage, an input current and an output current of the buck-or-boost switching regulator circuit, and a reference voltage, the first error signal generating means being within the analog control circuit, the control signal based on the first error signal; and
a control signal adjustment circuit coupled to an output of the first error signal generating means, the control signal adjustment circuit configured to prevent the control signal from getting high enough to be sliced by a boost voltage ramp signal or to be low enough to be sliced by a buck voltage ramp signal based on an input voltage and an output voltage of the buck-or-boost switching regulator circuit.

21. The buck-or-boost switching regulator circuit of claim 20, further comprising means for generating a second error signal based on the first error signal and a current through an inductor of the buck-or-boost switching regulator circuit, the second error signal generating means in an inner loop of the analog control circuit, the control signal based on the second error signal, the first error signal generating means in an outer loop of the analog control circuit.
